(19) United States
(12) Patent Application Publication
(10) Pub. No.: US 2025/0151676 A1
(43) Pub. Date: May 15, 2025

(54) ADDITIVES FOR INCREASING WATER HOLDING CAPACITY OF SOLID PLANT GROWTH MEDIA

(71) Applicant: LK MANAGEMENT PTY LTD, Queansland (AU)

(72) Inventors: Karl DUNBAR, Queensland (AU); Robert WALLACE, Queensland (AU)

(73) Assignee: LK MANAGEMENT PTY LTD, Queensland (AU)

(21) Appl. No.: 18/836,948

(22) PCT Filed: Feb. 9, 2022
(86) PCT No.: PCT/AU2022/050076

§ 371 Date: Aug. 8, 2024

(30) Foreign Application Priority Data
Feb. 16, 2021 (AU) 2021900381

(51) Int. Cl. A01G 24/13; A01G 24/15; C09K 17/04; C09K 17/08; C09K 17/40; C09K 101/00

(52) U.S. Cl. CPC A01G 24/13; A01G 24/15; C09K 17/04; C09K 17/08; C09K 17/40; C09K 2101/00

(57) ABSTRACT

Described herein are synergetic preparations for enhancing the water holding capacities of solid plant growth medium, consisting of a) ground zeolite, and b) powdered hypocalcic Montmorillonite expanse clay, and optionally c) granular expansive clay. Wherein the ratio of zeolite to Montmorillonite is between 1 to 0.25 and 1 to 30, and the ratio of powdered hypocalcic Montmorillonite expanse clay in the total amount of expansive clay is between 2 and 100%. Further optionally including components which aid product attractiveness, extend soil water retention, and assist plant and soil microbe growth.

### FIELD OF THE INVENTION

The invention relates to compositions comprising ground zeolite, and a hypocalcic Montmorillonite expansive clay, and optionally further a non hypocalcic expansive clay, wherein the ratio of zeolite to expansive clay is such that when the combination is present as an additive in a solid plant growth medium, such as a soil or a potting mix, there is a synergetic increase in the water retention capacity, along with an increase in the rate of hydration of non-powder granular expansive clay particles.

The preparations enable more efficient use of water and of dissolved plant nutrients, and more productive and robust plant growth. The synergy occurs under demanding real-world situations where the roots of plants are routinely present in media in which only suspended water remains present and where diffusion evaporation can occur. The compositions offer the opportunity of more environmentally responsible plant production, landscaping, park and sports ground maintenance and gardening.

Although the present invention will be described hereinafter with reference to its preferred embodiment, it will be appreciated by those of skill in the art that the spirit and scope of the invention may be embodied in many other forms.

### BACKGROUND OF THE INVENTION

Any discussion of the prior art throughout the specification should in no way be considered as an admission that such prior art is widely known or forms part of common general knowledge in the field.

There is a need for improving agricultural production both for returns on the amount of water used and for applied nutrients for plant production whether for production of food or raw material crops, for the production of grazing animals, for the production of decorative plants, or the maintenance of gardens, parks and recreational and sports grounds, and so on. The effects of climate insecurities, of land degradation including desertification, of the need to feed expanding populations, and higher quality of life expectations, etc mean that there is a demand for making better use of plant growing imports and minimising inefficient use. Previous published research on expansive clays being added to soils and potting mixtures to increase their water holding capacities, shows that the enhancements in water retention are often limited and fall far below that of the potential holdings seen for such clays when they are dispersed in water.

In a 2016 publication, (International Agrophysics., 2016, volume 30, pages 391-399 doi: 10.1515/intag-2016-0009, ‘Comparing the potentials of clay and biochar in improving water retention and mechanical resilience of sandy soil’ by Ayodele Ebenezer Ajayi and Rainer Horn), incorporated herein by reference, the incorporation of 2% weight/weight of a sodium bentonite or Montmorillonite clay material “an activated bentonite i.e., bentonite with smectites whose initial composition of alkaline earth cations has been replaced with Na+, in a technical process named alkali activation” with fine pure quartz sand, or approximately 33 g of sodium bentonite per litre resulted in only an increase of approximately 26 g of extra water being held at field capacity.

Considering the effects of Montmorillonite incorporation on soil water holding or retention the 2016 research publication (Forests 2016, volume 7, 36 ‘Effects of Bentonite, Charcoal and Corncob for Soil Improvement and Growth Characteristics of Teak Seedling Planted on Acrisols in Northeast Thailand’ by Masazumi Kayama et al), incorporated herein by reference, using an incorporation of greater than 42 g of bentonite i.e., Montmorillonite clay material per litre with sandy soil increased the soil water content, measured monthly over two years, before irrigation or rainfall by less than 50 g water per litre.

When investigating of the potential of improving the properties of soils, it is not only the effect on how much water that soil can hold at fully wetted capacity which may be of relevance. Soil saturation is a temporary situation as the water in saturated soils can drain away rapidly and as well the water can continue to freely drain away to leave low water contents in the soil having little long-term benefit for plants. The effect on the significant losses due to gravity driven drainage of water into the lower levels of the ground leading to deep percolation or deep drainage also needs to be considered. Downward water movement leading to deep percolation may not be important in relatively shallow depth plant pots and planting trays and elsewhere where there can be an air gap between the base of the solid plant growth media and any absorbent material or dispersing surface, the gap disrupting the paths of water movement so resulting in gravity driven water movement being restricted and resulting in extra water able to be retained in the growing media due to surface tension. In soils however deep percolation losses can be a serious limitation on the establishment of young plants and on the success of growing shallow and medium depth rooting plants in general.

It is found that the combination of ground zeolite and granular hypocalcic Montmorillonite clay incorporated into a potential plant growth media can increase the measured water holding capacity by less than the sum of the individual contributions would give, yet unexpectedly the addition of even a small portion of hypocalcic Montmorillonite expansive clay powder to the preparation increases the retention significantly. This synergy applies even when the proportions of the different components are varied and when the zeolite is altered and when the Montmorillonite is changed to a different chemical type such as sodium to calcium.

In greater detail, it has been discovered that, unexpectedly, when ground zeolites, which are a non-expansive clay possessing only very limited ability to hold water of that is a holding potential of approximately 55 g water per 100 g of the air dry weight of the zeolite, is mixed with powdered hypocalcic Montmorillonite expansive clay, or when the ground zeolite is mixed with combinations of powdered hypocalcic Montmorillonite expansive clay and granular non hypocalcic expansive clay, and these combinations are afterwards incorporated in a solid plant growth media, the water holding capacity of the material, can be drastically increased compared with the total holding capacity seen when the components are incorporated separately. Additionally, it is found that only a small proportion of the expansive clay in the preparation has to be hypocalcic Montmorillonite in order for this enhancement effect to be seen.

As well unexpectedly the rate of water uptake by the non-powder granular expansive clay is found to be very significantly increased when the preparation is hydrated compared with the hydration of the expansive clay by itself in a plant growth media. This offers the advantages of convenience, reduction in watering time requirements, and better utilisation of applied water. Naturally for best results the composition should be intimately mixed and evenly distributed through the treated solid plant growth media, endeavouring as much as is practical to avoid even small or thin pockets, patches or veins of the preparation occurring within the body of the plant growing medium.

It is an object of the present invention to overcome or ameliorate at least one of the disadvantages of the prior art, or to provide a useful alternative.

Unless the context clearly requires otherwise, throughout the description and the claims, the words “comprise”, “comprising”, and the like are to be construed in an inclusive sense as opposed to an exclusive or exhaustive sense; that is to say, in the sense of “including, but not limited to”.

Although the invention will be described with reference to specific examples it will be appreciated by those skilled in the art that the invention may be embodied in many other forms.

### SUMMARY OF THE INVENTION

According to a first aspect of the present invention there is provided a synergetic preparation for enhancing the water holding capacities of solid plant growth medium, the preparation comprising:
a) ground zeolite;
b) powdered hypocalcic Montmorillonite expansive clay, and optionally;
c) granular non hypocalcic Montmorillonite expansive clay.

In an embodiment, the hypocalcic Montmorillonite expansive clay has less than about 0.6 g of calcium per 100 g of the Montmorillonite component, on a dry weight basis.

In an embodiment, the hypocalcic Montmorillonite expansive clay has less than about 0.5 g of calcium per 100 g of the Montmorillonite component, on a dry weight basis.

In an embodiment, the hypocalcic Montmorillonite expansive clay has less than about 0.25 g of calcium per 100 g of the Montmorillonite component, on a dry weight basis.

In an embodiment, the hypocalcic Montmorillonite expansive clay has less than about 0.1 g of calcium per 100 g of the Montmorillonite component, on a dry weight basis.

In an embodiment, the weight ratio of zeolite to expansive clay is between about 1 to 0.25 and about 1 to 30.

In an embodiment, the weight ratio of zeolite to expansive clay is between about 1 to 0.5 and about 1 to 20.

In an embodiment, the weight ratio of zeolite to expansive clay is between about 1 to 0.8 and about 1 to 12.

In an embodiment, the weight ratio of powdered hypocalcic Montmorillonite expanse clay in the total amount of expansive clay is between about 2 and 100%.

In an embodiment, the weight ratio of powdered hypocalcic Montmorillonite expanse clay in the total amount of expansive clay is between about 5 and 100%.

In an embodiment, the weight ratio of powdered hypocalcic Montmorillonite expanse clay in the total amount of expansive clay is between about 8 and 100%.

In an embodiment, the water in the solid plant growth medium is essentially only suspended water.

In an embodiment, the water in solid plant growth medium is subject to ongoing diffusion evaporation.

In an embodiment, the hydration rate of the non hypocalcic Montmorillonite expansive clay particles are enhanced compared with the rates for non hypocalcic Montmorillonite expansive clay particles in the absence of the zeolite.

In an embodiment, the zeolite has a majority content of mordenite, or clinoptilolite, or a combination of the two chemical forms.

In an embodiment, the ground zeolite particles have an appropriate portion of particles able to be well mixed with the expansive clays.

In an embodiment, the powdered hypocalcic Montmorillonite expansive clay is an alkali metal activated Montmorillonite clay.

In an embodiment, the powdered alkali metal activated expanse clay is activated after the combination of the ingredients as a result of co-incorporation of an alkali metal carbonate or carbonates.

In an embodiment, the powdered hypocalcic Montmorillonite expansive clay is a sodium activated Montmorillonite clay.

In an embodiment, the powdered hypocalcic Montmorillonite expansive clay is an acid activated Montmorillonite clay.

In an embodiment, the powdered hypocalcic Montmorillonite expansive clay is a natural Montmorillonite clay.

In an embodiment, the powdered hypocalcic Montmorillonite expansive clay is a synthetic Montmorillonite clay.

In an embodiment, the preparation further comprises one or more organic polymers for temporary water holding capacity enhancement.

In an embodiment, the one or more organic polymers are selected from the group consisting of sodium carboxymethyl cellulose, xanthan gum, guar gum, gum arabic, carob bean gum, locust bean gum, tara gum, konjac gum, gellan gum, methyl cellulose, hydroxypropyl methylcellulose, and hydroxyethyl methyl cellulose.

In an embodiment, the one or more organic polymers are selected from either sodium carboxymethyl cellulose or xanthan gum.

In an embodiment, the preparation further comprises aids for plant growth, or soil microbes, or promoters of soil microbes, or assist in effective product incorporation and distribution into a solid plant growth media.

In an embodiment, the plant growth media is modified natural soil, or altered soil, or synthetic soil, or soil substitute, or sand, or potting mixes, composted material, raised bed media, or hydroponic media, or mushroom growth media, or epiphyte media.

In an embodiment, the plant growth media utilises one or more of plastics, expanded mica, expanded perlite, heat treated vermiculite, treated barks, quartz sand, silt, grit, gravel, ground and fragmented rock, mineral dust, pumice, wood fibres, shredded wood, peat, coconut coir, sawdust, fresh bark, aged bark, composted bark, peanut shells, cork, rice hulls, coffee grinds, sugarcane leaves, sugarcane tops, sugarcane bagasse, cereal straw, chaff, and compost.

According to a second aspect of the present invention there is provided modified plant growth media containing an additive comprising a synergetic preparation for enhancing the water holding capacities of solid plant growth medium, the preparation comprising:
a) ground zeolite;
b) powdered hypocalcic Montmorillonite expansive clay, and optionally;
c) granular non hypocalcic Montmorillonite expansive clay.

In an embodiment, the hypocalcic Montmorillonite expansive clay has less than about 0.6 g of calcium per 100 g of the Montmorillonite component, on a dry weight basis.

In an embodiment, the hypocalcic Montmorillonite expansive clay has less than about 0.5 g of calcium per 100 g of the Montmorillonite component, on a dry weight basis.

In an embodiment, the hypocalcic Montmorillonite expansive clay has less than about 0.25 g of calcium per 100 g of the Montmorillonite component, on a dry weight basis.

In an embodiment, the hypocalcic Montmorillonite expansive clay has less than about 0.1 g of calcium per 100 g of the Montmorillonite component, on a dry weight basis.

In an embodiment, the weight ratio of zeolite to expansive clay is between about 1 to 0.25 and about 1 to 30.

In an embodiment, the weight ratio of zeolite to expansive clay is between about 1 to 0.5 and about 1 to 20.

In an embodiment, the weight ratio of zeolite to expansive clay is between about 1 to 0.8 and about 1 to 12.

In an embodiment, the water in the modified solid plant growth medium is essentially only suspended water.

In an embodiment, the water in the modified solid plant growth medium is subject to ongoing diffusion evaporation.

In an embodiment, the hydration rate of the non hypocalcic Montmorillonite expansive clay particles are enhanced compared with the rates for non hypocalcic Montmorillonite expansive clay particles in the absence of the zeolite.

In an embodiment, the zeolite has a majority content of mordenite, or clinoptilolite, or a combination of the two chemical forms.

In an embodiment, the powdered hypocalcic Montmorillonite expansive clay is an alkali metal activated Montmorillonite clay.

In an embodiment, the powdered hypocalcic Montmorillonite expansive clay is a sodium activated Montmorillonite clay.

In an embodiment, the powdered hypocalcic Montmorillonite expansive clay is an acid activated Montmorillonite clay.

In an embodiment, the powdered hypocalcic Montmorillonite expansive clay is a natural Montmorillonite clay.

In an embodiment, the powdered hypocalcic Montmorillonite expansive clay is a synthetic Montmorillonite clay.

In an embodiment, the further components include organic polymer or polymers for temporary water holding capacity enhancement.

In an embodiment, the organic polymer or polymers are selected from the group consisting of sodium carboxymethyl cellulose, xanthan gum, guar gum, gum arabic, carob bean gum, locust bean gum, tara gum, konjac gum, gellan gum, methyl cellulose, hydroxypropyl methylcellulose, and hydroxyethyl methyl cellulose.

In an embodiment, the organic polymer or polymers are selected from either sodium carboxymethyl cellulose or xanthan gum.

In an embodiment, the media further comprises aids for plant growth, or soil microbes, or promoters of soil microbes.

In an embodiment, the plant growth media is modified natural soil, or altered soil, or synthetic soil, or soil substitute, or sand, or potting mixes, composted material, raised bed media, or hydroponic media, or mushroom growth media, or epiphyte media.

In an embodiment, the plant growth media utilises one or more of plastics, expanded mica, expanded perlite, heat treated vermiculite, treated barks, quartz sand, silt, grit, gravel, ground and fragmented rock, mineral dust, pumice, wood fibres, shredded wood, peat, coconut coir, sawdust, fresh bark, aged bark, composted bark, peanut shells, cork, rice hulls, coffee grinds, sugarcane leaves, sugarcane tops, sugarcane bagasse, cereal straw, chaff, and compost.

In general terms, the invention is concerned with a composition comprising ground zeolite and hypocalcic Montmorillonite expansive clay, which gives a preparation that when incorporated in a solid plant growth medium increases the water holding capacity in a synergetic manner compared with the sum of the individual enhancements in water holding capacity achieved by the same amount of zeolite and the same amount of hypocalcic Montmorillonite expansive clay incorporated each on their own separately in the medium. This synergy applies even when the proportions of the different components are varied and when the zeolite is altered and the form of the hypocalcic Montmorillonite expansive clay is altered. In addition, the time taken for the hydration of expansive clay particles is able to be reduced.

Optionally the composition may include further components for the purpose of enhanced economics and functionality.

### BRIEF DESCRIPTION OF THE DRAWINGS

A preferred embodiment of the present invention will now be described with reference to the accompanying drawings in which:

FIG. 1 is a photograph contrasting the comparative growth rates of cannabis plants with (a) and without (b) applying the present invention at a dosage rate of about 10 g/L of coconut coir substrate. The plants were established on the same day in otherwise identical growth media and were subject to the same light, atmosphere and watering regimen throughout. The only difference was the application, or otherwise, of the present invention.

FIG. 2 shows comparative 7-day growth in tomato plants applying the present invention at a dosage rate of about 10 g/L of coconut coir substrate. The plants were established 7 days apart in identical growth media comprising the same application of the present invention and were subject to the same light, atmosphere and watering regimen throughout.

FIG. 3 is a photograph contrasting the comparative growth rates of blueberry plants with (b) and without (a) applying the present invention. The plants were established on the same day in otherwise identical growth media at a dosage rate of about 10 g/L of coconut coir substrate and were subject to the same light, atmosphere and watering regimen throughout. The only difference was the application, or otherwise, of the present invention.

FIG. 4 is a photograph contrasting the comparative growth rates of hemp plants with (a) and without (b) applying the present invention when grown in a field trial. The plants were established on the same day in otherwise identical growth media at a dosage rate of about 10 g/L of coconut coir substrate and were subject to the same light, atmosphere and watering regimen throughout. The only difference was the application, or otherwise, of the present invention.

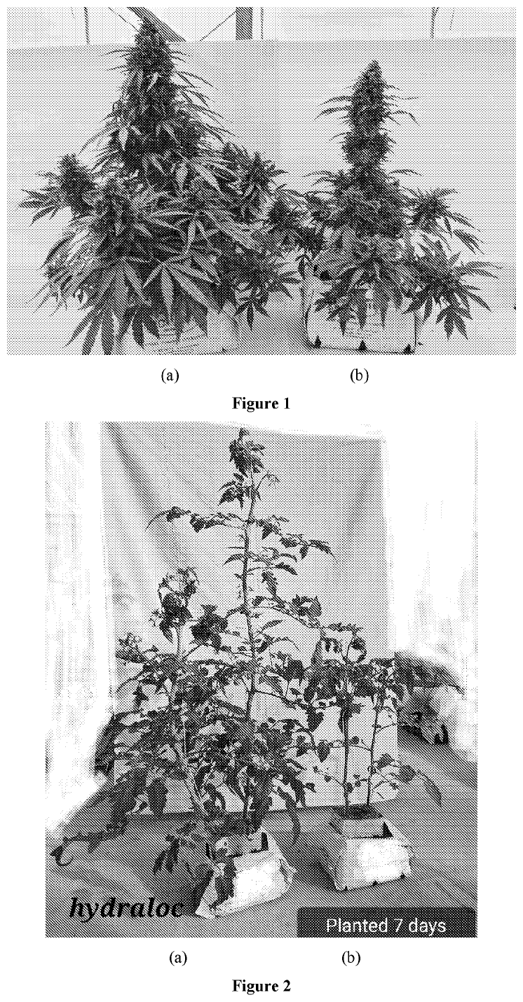

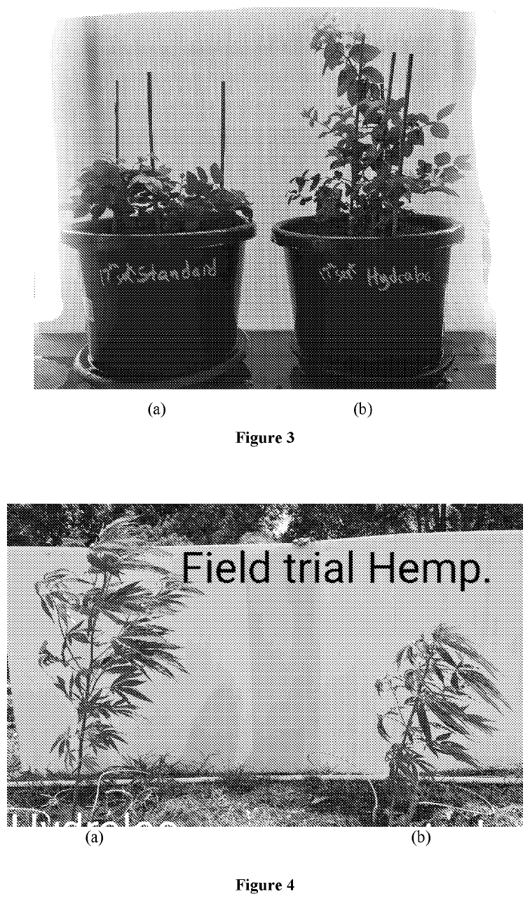

### DETAILED DESCRIPTION OF THE INVENTION

Synergetic preparations for enhancing the water holding capacities of solid plant growth medium, comprising a) ground zeolite, and b) powdered hypocalcic Montmorillonite expansive clay, and optionally c) granular small sized pieces hypocalcic Montmorillonite expansive clay, plus also offering enhanced water uptake dynamics.

The ratio of zeolite to Montmorillonite is between 1 to 0.25 and 1 to 30, and the ratio of powdered hypocalcic Montmorillonite expansive clay in the total amount of expansive clay is between 2 and 100%, preferably the ratio of zeolite to Montmorillonite is between 1 to 0.5 and 1 to 20, and the ratio of powdered hypocalcic Montmorillonite expansive clay in the total amount of expansive clay is between 5 and 100%, and more preferably the ratio of zeolite to Montmorillonite is between 1 to 0.8 and 1 to 20, and the ratio of powdered hypocalcic Montmorillonite expansive clay in the total amount of expansive clay is between 8 and 100%.

Particularly favoured options of the invention are for the zeolite to have a majority content of mordenite, or clinoptilolite, or a combination of the two chemical forms, the powdered hypocalcic Montmorillonite expansive clay is either an alkali metal activated expanse clay or is a natural hypocalcic Montmorillonite expansive clay and the granular expansive clay is a natural sodium Montmorillonite expansive clay.

When granular expansive clay such as a natural sodium Montmorillonite is incorporated, the expansive clay should be mixed thoroughly with the powdered hypocalcic Montmorillonite expansive clay, before subsequently the combination being mixed with the ground zeolite.

The ingredients of the invention can be directly physically mixed. However, if powdered hypocalcic Montmorillonite expansive clay fraction is an alkali metal activated expansive clay this may be generated after the initial mixing by subsequent alkali metal activation such as by the intimate contact between the expansive clay with incorporated sodium carbonate powder. The ground zeolite fraction used is to have appropriate portion of particles sized to be able to be well mixed with the expansive clays.

Further optionally including components which aid product attractiveness such as economics and ease of application, and functional effectiveness such as further increasing soil water retention capacity, or soil microbes, or promoters plant and soil microbe growth, can be incorporated.

While non hypocalcic Montmorillonite clay can be changed and synergy still be achieved, such as if the selected Montmorillonite is changed to a different chemical type, for example sodium to calcium, it is however advantageous to appropriately select ingredients as even with synergy occurring the changing from a high absorbent alkali metal Montmorillonite to a low absorbent calcium Montmorillonite results in a much lower increase in water retention capacity.

The ingredients of the preparations of the patent are widely available and do not face the challenges which can face organic polymer soil water retention agents. Organic polymer soil water retention agents are often broken down rapidly by soil microbes, and in the case of synthetic organic water soil water holding polymers yield decay products with unknown and potentially negative effects on the environment.

Furthermore, unlike many superabsorbent polymers used as solid amendments combinations of the product of the invention are able to be classified as permitted for organic gardening and agriculture. In addition, the preparations can be used to reduce or even replace components of non-soil media which may not be sustainably sourced such as peat moss in potting mixtures.

Applications of the plant growth media applications utilising the water holding capacity additives can include but are not limited to agricultural, horticultural, vinicultural, orchards and forestry, plant nursery operations, green and glass houses, garden plants, indoor plants, potted plants, flower production, decorative roles including epiphytes, maintenance of parks, sports grounds, lawns and erosion control areas, during land reclamation, and in restoration of degraded and contaminated areas.

The zeolite incorporation being additionally advantageous for its ability to extend the range of retained plant nutrients of those able to be retained by Montmorillonites and organic water retaining polymers. The products of the invention are able to achieve greater ecologically responsibility by offering better fertiliser retention in soil close to plant roots and less leaching into water tables and contributing to eutrophication of water bodies. Additionally, in contaminated soils the zeolite can help lock up toxic compounds, both organic molecules and heavy metals.

The incorporated expansive clay such as a natural sodium Montmorillonite being additionally advantageous for its ability to absorb plant germination and seedling restricting phenolic molecules found in certain potting ingredients such as unaged, weathered or composted pine bark, hardwood bark, hardwood saw dust, and coir peat, examples of such phenolic molecules include catechins and leachable tannins of coconut material.

At least a proportion of the zeolite can be preloaded with soluble plant nutrient compounds, but which pass into the solid growth media over time. These can be in the form of pure urea or of diluted urea or of solutions mineral salts dissolved in urea which are able to be melted with heating and be absorbed into zeolite particles yet are solid phases at storage and environmental temperatures. Similarly, a proportion of the Montmorillonite used may naturally, or may be modified to, hold plant nutrient mineral ions such as potassium.

Other potential optional components of the preparations include but are not limited to: plant maintenance and growth promotional materials such as suitable fertilising compounds and their precursors, soil microbes such as mycorrhizal fungi, soil microbe promoters such as organic material, seaweed extracts and specific trace elements, biochar, repellents of soil plant parasites, pesticides, and soil wetting agents, plus also additives which aid product delivery for example differently coloured particles to monitor evenness of distribution of additives incorporated into soils etc, and suitable diluents to enable machinery to effectively achieve appropriate distribution within treated plant growth media.

While one of the advantages of the preparations of the invention is the ability to permanently enhance the water and mineral holding nature of many soils, this does not exclude the optional incorporation of water retaining materials of a transitional nature, such as organic polymers which are biodegraded by soil microbes. There are many potential organic polymer soil aids, such as food and cosmetic ingredient hydrocolloids, the most favoured are those with high enhancements at low incorporation levels and which are able to be sustainably sourced, are economical, and for which there are no concerns about the possibility of decay compounds having toxic attributes. Such polymers can also promote the content of advantageous soil microbes in the plant growth media.

One particularly favoured transilient or biodegradable water retention aid, is sodium carboxymethyl cellulose, also referred to as NaCMC, though other hydrocolloid compounds or food gums approved for food use such as xanthan gum, guar gum, gum arabic, carob bean gum, locust bean gum, tara gum, konjac gum, gellan gum, methyl cellulose, hydroxypropyl methylcellulose, and hydroxyethyl methyl cellulose are suitable. It has been found that thoroughly mixing a small portion of NaCMC or xanthan gum with the basic preparation, results in the gum being able to efficiently take up water due to preventing lumping of the hydrating hydrocolloid.

The NaCMC chains may optionally be cross-linked to retard decay by soil microbes and their enzymes, the cross linking may involve covalent bonding or bonding by bridging multivalent cations such as aluminium ions. The presence of such polymers in the growth media can also be achieved by the incorporation of suitable microbes and or stimulating growth factors of soil microbes which de novo synthesise water holding organic polymers.

Without being restricted in any way, the preparations could be mixed dry into dry or damp but non wet plant growing media, utilising a process which achieves even dispersion in the medium and avoids even small or thin pockets, patches or veins of the preparation occurring within the body of the plant growing medium.

In another approach the preparation may be first mixed and diluted with another material, such as a small portion of the growing media involved, in order to better enable even thorough mixing in the final medium. After incorporation, the treated plant growing media is supplied with water in sufficient quantity and duration to achieve proper extensive hydration of the preparation and its enhancement in water holding capacity. The duration period needed can depend on the nature of the growth medium, thus treated dehydrated potting mixture may be slower than treated dry sand to achieve proper hydration.

Hydration can be carried out in more than one wetting step, such as an initial watering followed one or more additional waterings. In addition to the nature of the growing media treated hydration rate may also be affected by factors such as temperature, water salinity and whether water is able to readily drain away.

Application rates of the mixtures of the invention should be adjusted for the specific solid plant growth media being modified to achieve appropriate benefits, for example the resulting modified solid plant growth media at field capacity should still have of air pore volume sufficient for roots of the grown plant species to be healthy and function properly.

It is of relevance to evaluate any additive with potential to increase the water holding capacity under the conditions under which it is most likely to improve plant growing conditions for agricultural and garden plants, and in soils this occurs between rainfalls or irrigations when soils have been drained of their gravitational water and water stress can develop, as well soils are routinely subject further to water reduction due to diffusion evaporation.

Also, it is important that capillary water is absent when testing, given that capillary zones occur above water tables or can be perched above water imperious layers in the ground, and such capillary water zones are not typical of the conditions that plants which could suffer water stress shall have root access to.

In draining trials the material should not be on a solid base, a capillary water zone does not only require the presence of a layer of liquid water. It has been found that in a heap of sand placed in a box with holes in the solid base allowed to drain for a full day and no further water was coming from the base, that the water content sand at 20 cm above the base was approximately 29% while at 40 cm it was approximately 12.5%. In other situations, such as some silt being present then the height of the capillary affected zone can be even higher.

For clear evaluations it is preferably that trials should involve media with suspended water only present and also preferably last long enough to catch that the evaporation losses from the media are at least not being assisted by additives. Testing of soil additives should be designed so that the conditions in the soil sample model are similar to those of an upper unsaturated or fully gravitationally drained soil zone, this can be achieved by having the base of the soil or other media is in truly effective contact, and for a sufficient time, with a highly absorbent matrix able to act as a sink or drain for gravitational water.

Diffusion evaporation affects the upper portions of a soil and is of importance for shallow rooted crops and lawns as well as young plants becoming established. For sands evaporation can reduce sufficient moisture contents to a depth of a significant number of centimetres in a few days. To check that an additive does not enhance evaporation but preferably shows that water losses are delayed, investigations can employ media depths which are relatively shallow. We have found that for sand-based media a depth of approximately 14 cm enables the occurrence of significant decreases in volumetric water content of the media over several days at room temperature.

### Terminology and Definitions

In describing and claiming the present invention, the following terminology will be used in accordance with the definitions set out below. It is also to be understood that the terminology used herein is for the purpose of describing particular embodiments of the invention only and is not intended to be limiting. Unless defined otherwise, all technical and scientific terms used herein have the same meaning as commonly understood by one having ordinary skill in the art to which the invention pertains.

As used herein, the plural forms are intended to include the singular forms as well, and the singular forms are intended to include the plural forms as well unless the context clearly indicates otherwise.

Synergy is the creation of a whole that is greater than the simple sum of its parts or is the creation of an effect that is greater than the simple sum of the effects of its parts. The preparations of the invention show greater enhancement water holding capacities when incorporated in a plant growth medium such as a sand than the sum or combined of the enhancements achieved when the same amounts of the individual ingredients are incorporated separately by themselves. Synergy enables lower quantities of additives to be utilised.

Water Holding Capacity or Field Capacity: Soil water is in different classes for plants, such as unavailable or chemically locked up water; water can be held loosely in large pores and spaces between soil particles but which quickly drains away once rainfall or irrigation—moving down through the soil under the pull of gravity taking a day or so to do so for a soil which has been water saturated, this is known as gravitational water. The water remaining after the gravitational water has gone is known as suspension water, most suspension water can be absorbed by plants to a greater or lesser extent, but the absorbable amount varies depending on the plant species and growth stage. For comparison purposes it is the soil field capacity that is routinely used, this is the amount of water held in soil which has been saturated and then allowed to drain for one to three days. For shallow depths of soil or with sand the drainage time is of course shorter.

Hydration or the absorption of water by the preparations is required for the preparations to retain the water in the plant growth media. However, this is more than a simple and rapid taking up of moisture process such as absorption of water by the fibres of a cloth or paper towel, where the moisture can be only loosely held and readily lost. Use of water coloured with a dye shows that the initial wetting of Montmorillonite granules is sped up when the Montmorillonite granules are in conjunction with ground zeolite and a alkali metal activated Montmorillonite powder, however it takes time for the fuller Montmorillonite hydration to occur as shown by macroscope physical changes to the granules over many minutes to hours depending on the individual formulations. Fortunately, it has been found that a single good soaking of a treated growing media sample and permitting the media to remain wet for an extended time can achieve extensive hydration and thus extensive enhancements of water holding capacities. However, in field and maybe in potted plant situations where significant rates of water loss occur due to water draining away, more than one soaking during the initial hydration phase time may be of use to effectively obtain the extensive hydrating of additives, and the requirements of individual situations should be checked.

Zeolites these are clay type aluminosilicate materials with a rigid three-dimensional structure containing different sized pores and channels able to hold a range of different molecules and ions. There are number of different classes offering flexibility in absorption behaviour. Zeolites can hold exchangeable metal ions such as potassium, magnesium, calcium and sodium. Zeolites can also hold nitrate and ammonium ions.

Ground zeolite can be achieved by breaking up zeolite by physically disruptive methods including but not limited to crashing, cutting by fast moving blades such as processed dry in a blender. A broad size range of particles is acceptable, however separating in specific size ranges by for example sieving in order to achieve better dry mixing properties is an optimum. It is preferred that the ground pieces be less than 0.85 mm diameter, and more preferred that a significant proportion be less than 0.5 mm but larger size may be included so long as sufficient less than 1 mm pieces are present to achieve the enhancement of the water capacity of the expansive clay present upon proper hydration. The ground zeolite fraction used is to have appropriate portion of particles sized to be able to be well mixed with the expansive clays.

Expansive clays are minerals are hydrous aluminium phyllosilicates, holding variable amounts of different metal cations. Clay is a finely-grained natural rock or soil material, regarded as having maximum particle sizes less than 1 to 5 μm. Expansive clays are clays which show shrink-swell capacity that is they will expand when wet and retract when dry, and additionally those that expand their volume by gel formation.

Montmorillonite is a subclass of smectite which are 2:1 phyllosilicate mineral, with layers consisting of two outer tetrahedral sheets of silica sandwiching a central octahedral sheet of alumina. In Montmorillonite there is isomorphous substitution of magnesium for aluminium in the central alumina plane. The properties of Montmorillonite vary depending on the extent of the magnesium for aluminium substitution, and on the makeup and the ion size and ionic charge of the cations associated with the sheets. Water can be absorbed into interlayer spaces and be associated with surfaces of external surfaces of the layers. The Montmorillonite component of a material on an anhydrous basis can be 100% or especially when the material derived from natural sources, because of dilution with impurities, can be less than 100%. Montmorillonite rich materials are also known as bentonite clays.

Hypocalcic Montmorillonite clays are Montmorillonite clays with unusually low calcium contents. Material wherein the calcium content of the Montmorillonite component, excluding hydrating water that is on a dry weight basis, is less than 0.6 g per 100 g, preferably 0.5 g or less per 100 g, more preferably 0.25 g or less per 100 g, and most preferably less than 0.1 g per 100 g. Hypocalcic Montmorillonite clays include but are not limited to Montmorillonite of natural origin such as resulting from volcanic ash deposited into an arm of the sea, with or without being subjected to concentrating processing; or can be chemically modified natural Montmorillonite material with or without being subjected to concentrating processing; or can be synthesised Montmorillonite material; or a combination thereof. The chemical conversion of non-hypocalcic Montmorillonite clay to hypocalcic Montmorillonite clay can involve replacement of calcium ions by alkali metal activation or by acid activation.

Concentrating processing of the clay components, includes any processing which separates out non-Montmorillonite material from Montmorillonite material, and similarly should it be required for concentrating processing of zeolite material includes any processing which separates out non zeolite material from zeolite material. Such purifications include but are not limited to sedimentation, centrifugal separation, aero separation, and sieving techniques, or the leaching of carbonates, or the leaching of organic components.

A granular material is a conglomeration of discrete solid, macroscopic particles characterised by a loss of energy whenever the particles interact such as friction when grains collide, particle sizes can range from about 1 μm to large asteroids. The non-hypocalcic expansive clay can be a majority of small granules though a proportion of powder may be present. Non-hypocalcic expansive clay granules are preferred to be less than 2 mm diameter, more preferred to be less than 1 mm diameter, most preferred to less than 0.85 mm. Larger sized pieces may be present but not to the extent that the enhancement of the water capacity of the expansive clay present upon proper hydration becomes insignificant.

Alkali metals are the Group IA (1) elements of the periodic table, lithium, sodium, potassium, rubidium, caesium, and francium. These elements form stable singly charged cations and so not able to form direct links or bridges between the lattice layers of clays. The reference to any single alkali metal does not exclude the presence of other cations including non-alkali metal cations.

Alkali metal activated expansive clays and Alkali metal expansive clays are expansive clays may have as non-lattice cations or exchangeable cations, cations of a single alkali metal element, cations of a mixture of alkali metal elements, and optionally additional non alkali metal cations.

Sodium Activated Expensive Clay can also be referred to as sodium exchanged expansive clay as in sodium exchanged Montmorillonite clay, or sodium-beneficiated expansive clay as in sodium-beneficiated calcium Montmorillonite. In these materials other positively charged cations in an expansive clay such as calcium ions are replaced by sodium ions as result of processing. The processing can include but is not limited to exposing a calcium Montmorillonite to sodium carbonate which can be a wet processing or the materials may be non-wetted and rely on the moisture held in the Montmorillonite to enable exchange of cations to take place. For dry processing the finer the particle sizes the faster is the cation exchange. Blends of raw Montmorillonite and sodium carbonate may be extruded to promote activation.

Further Alkali Metal Activated Expensive Clays include potassium, or potassium plus sodium activated expansive clays. In these materials other positively charged cations in an expansive clay such as calcium ions are replaced by desired alkali metal ions as a result of processing. The processing can include but is not limited to exposing a calcium Montmorillonite to alkali metal carbonates which can be a wet processing or the materials may be non-wetted and rely on the moisture held in the Montmorillonite to enable exchange of cations to take place. For dry processing the finer the particle sizes the faster is the cation exchange. Blends of raw Montmorillonite and alkali metal carbonates may be extruded to promote activation.

For the purpose of the patent alkali metal activation can take place after a powdered expansive clay such as a Montmorillonite has been mixed with ground zeolite, in the presence of an alkali metal carbonate powder such as sodium carbonate.

The alkali metal activated expansive clay powder, the particle size is preferred to be less than 0.25 mm diameter, much finer particle sizes are acceptable. Particles larger than 0.25 mm may be present but not to the extent that the enhancement of the water capacity of the non-alkali metal activated expansive clay present becomes insignificant upon proper hydration.

All references to sodium activated expensive clay include activated expensive clay with other monovalent cations, such as potassium ions, in addition to sodium ions. All references to sodium activated Montmorillonite include activated Montmorillonite containing other monovalent cations, such as potassium ions, in addition to sodium ions. All references to sodium Montmorillonite include Montmorillonite s with other cations, such as potassium ions, in addition to sodium ions.

Solid Plant Growth Media are materials that plants grow in or on, and support plant growth and can either be a solid or a liquid. Unless otherwise specified all references to plant growth media are to solid media. Plant growth media can include but are not limited to soil, sand, potting mixes, or soil substitutes such as loose assemblages of synthetic material or of non-synthetic materials or modified natural materials and loose mixtures of synthetic and non-synthetic materials and modified natural materials, used in but not limited to ground applications; to growth media restricted by physical barriers such as walled raised beds, cliff holes, pots, seeding bags and nursey trays, troughs, growing plants in grow bags or mini gardens, hydroponics utilising organic media held in bags etcetera, plant towers, and mushroom culture media made from smaller sized particle ingredients; or growth media not retained by solid walls such as heaped raised beds and mesh held media for epiphytes. Synthetic materials can include plastics, expanded mica, expanded perlite, heat treated vermiculite, treated barks. Non synthetic materials and modified natural materials include quartz sand, silt, grit, gravel, ground and fragmented rock, mineral dust, pumice, wood fibres and shredded wood and sawdust, bark, peat, coconut coir, fresh bark, aged bark, composted bark, peanut shells, cork, rice hulls, coffee grinds, sugarcane leaves, tops and bagasse, compost; and smaller sized particle ingredients for mushroom culture such as compost, sawdust, cereal straw, chaff, and bagasse.

Unsaturated Soil Zone is the soil above the water table is known as the vadose (Shallowly in Latin) zone consists of three basic zones-firstly the soil moisture zone is the depth of soil from which plant roots extract water, then underneath this is the Vadose intermediate zone, and finally deepest the capillary zone where water is held due to the force of surface tension being able to counter the force of gravity.

Suspended Water refers to the water remaining in the upper or unsaturated soil zone once gravitational water has drained away and which lies above the capillary zone or fringe. Water retained by attraction to the surrounding soil particles, as well as by the inter-molecular attractions exerted by the water molecules on each other.

“The suspended water is present in the strata, which overlie the capillary fringe of various water-bearing horizons . . . . The suspended water generally is represented by the combination of loosely bound and free water.” From ‘Hydrophysical properties and moisture regime in the unsaturated zone’, by A. A. Rode, pages 33-48, of ‘Water in the unsaturated zone’ Proceedings of the Wageningen Symposium, ASH/AIHS—Unesco, Studies and reports in hydrology, Published in 1969 by the International Association of Scientific Hydrology, Braamstraat 61, Gentbrugge and by Unesco, Place de Fontenoy, 75 Paris-7e, incorporated herein by reference.

Importantly under normal growing conditions for agricultural crops and garden plants, etc., suspended water in the soil provides the only available water much of the time.

It will be appreciated that the invention uses natural and substantially source-able components combinations to better increase the water retention capacities of a solid plant growth medium such as sand and sandy soils, and media in situations of special advantage where necessary water replenishment by rainfall or irrigation is difficult, costly, or economically challenging. As well it can enable better water and water dissolved plant nutrients usage and less waste by lessened amounts of drainage liquid and increased retention of moisture and dissolved plant nutrients within reach of plant roots.

There is a need for improving agricultural production both for returns on the amount of water used and for the nutrients applied for plant production, whether for production of food or raw material crops, for the production of grazing animals, for the production of decorative plants, or the maintenance of gardens, parks and recreational and sports grounds, etc. The effects of climate insecurities, of land degradation including desertification, of the need to feed expanding populations, and higher quality of life expectations, etcetera mean that there is a demand for making better use of plant growing inputs and minimising inefficient use.

Previous published research on plain expansive clays being added to soils and potting mixtures to increase their water holding capacities, shows that the enhancements in water retention are often limited and fall far below that of the potential holdings seen for such clays when dispersed in water.

Unless the context clearly requires otherwise, throughout the description and the claims, the words “comprise”, “comprising”, and the like are to be construed in an inclusive sense as opposed to an exclusive or exhaustive sense; that is to say, in the sense of “including, but not limited to”.

As used herein, the phrase “consisting of” excludes any element, step, or ingredient not specified in the claim. When the phrase “consists of” (or variations thereof) appears in a clause of the body of a claim, rather than immediately following the preamble, it limits only the element set forth in that clause; other elements are not excluded from the claim as a whole. As used herein, the phrase “consisting essentially of” limits the scope of a claim to the specified elements or method steps, plus those that do not materially affect the basis and novel characteristic(s) of the claimed subject matter.

With respect to the terms “comprising”, “consisting of”, and “consisting essentially of”, where one of these three terms is used herein, the presently disclosed and claimed subject matter may include the use of either of the other two terms. Thus, in some embodiments not otherwise explicitly recited, any instance of “comprising” may be replaced by “consisting of” or, alternatively, by “consisting essentially of”.

Other than in the operating examples, or where otherwise indicated, all numbers expressing quantities of ingredients or reaction conditions used herein are to be understood as modified in all instances by the term “about”, having regard to normal tolerances in the art. The examples are not intended to limit the scope of the invention. In what follows, or where otherwise indicated, “%” will mean “weight %”, “ratio” will mean “weight ratio” and “parts” will mean “weight parts”.

The term “substantially” as used herein shall mean comprising more than 50% by weight, where relevant, unless otherwise indicated.

The term “about” should be construed by the skilled addressee having regard to normal tolerances in the relevant art.

The recitation of a numerical range using endpoints includes all numbers subsumed within that range (e.g., 1 to 5 includes 1, 1.5, 2, 2.75, 3, 3.80, 4, 5, etc.).

The terms “preferred” and “preferably” refer to embodiments of the invention that may afford certain benefits, under certain circumstances. However, other embodiments may also be preferred, under the same or other circumstances. Furthermore, the recitation of one or more preferred embodiments does not imply that other embodiments are not useful and is not intended to exclude other embodiments from the scope of the invention.

It must also be noted that, as used in the specification and the appended claims, the singular forms “a”, “an” and “the” include plural referents unless the context clearly dictates otherwise.

The prior art referred to herein is fully incorporated herein by reference unless specifically disclaimed.

Although example embodiments of the disclosed technology are explained in detail herein, it is to be understood that other embodiments are contemplated. Accordingly, it is not intended that the disclosed technology be limited in its scope to the details of construction and arrangement of components set forth in the following description or illustrated in the drawings. The disclosed technology is capable of other embodiments and of being practiced or carried out in various ways.

### Examples

The invention will now be described with the following non-limiting examples demonstrating enhancements in water holding capacities and the flexibility available in ratios and proportions of ingredients able to result in enhanced capacities.

First demonstration procedure: The testing vessels used were clear perplex tubes, 10 cm internal diameter, height 20.2 cm, sealed at the base with a disk of a coarse paper towel held in place by a wire mesh, the vessel being held in place and vertical upon a stand above a 10 cm wide hole. Once loaded the weight of the sand ensured that the wire mesh curved sufficiently that there could be good contact with any absorbent material held underneath the stand.

The standard procedure was for a dry quantity of 1.8 kg or more than a litre volume of sand or sand based medium to be tested.

The dry individual ingredients or dry preparations were thoroughly mixed with the dry sand in a bowl and loaded into the column.

At least one flush of the loaded column contents with a litre of tap water was carried out. The bowl of a plastic spoon was placed concave side up on the surface of the settled sand or the other media in the column and water poured gently onto the plastic piece to minimise disturbance of the column contents. A head of liquid water was maintained constantly above the surface until the full litre had drained into the pure or treated sands, with the surplus coming out the bottom of the column. Water and room temperature were normally in the mid-twenties degrees Celsius.

Without contact with an absorbent material, it was found that wetted sand-based mixtures did not completely drain away but retained extensive quantities of water. Thus, it is possible to leave a mixture wetted by even a single flush over a period of hours or even overnight to ensure fuller hydrations of the incorporated ingredient or preparation. Hydration was routinely monitored by including a food dye in the water and observing the extent of colouring and physical integrity of Montmorillonite materials.

Measures of field capacity are achieved by firmly contacting the paper disk coated base of the column with an absorbent material routinely upturned paper rolls with at least the upper 2 cm of their cardboard inner tubes removed to ensure extensive contact with the base of the sealed columns. It is found with fine sand-based media that contact with a stack of paper towels is ineffective in ensuring that a capillary zone does not remain in the column held material. Normally the gravity water is close to fully removed in a matter of hours, however comparisons were done after at least 24 hours or a few days draining has occurred.

The water retained by 1.8 kg of wetted commercial washed light-coloured quartz sand, after the same durations of draining, were used as background to give the measures of increase in water retention capacity for the different ingredients and preparations. The columns had covers to restrict evaporation losses.

Routinely unless otherwise stated 4% weight:weight of ingredients and preparations were tested, that is 72 g in a total of 1800 g, and the wetted volume was approximately 1.1 L. The hydrated media depth was approximately 14 cm which ensures quantitative gravity water separation out in less than a day. In addition, this is a depth within the depth found for evaporation occurring from sand bodies.

Potting mixture Trials, as the media were lower in density than the sand and sand based mixtures the dry weight quantities were adjusted so that the hydrated volumes were greater a litre, but otherwise followed the general procedure above, except that due to the dark colour of the media hydration was not able to be monitored by including a food dye in the water and observing the extent of colouring and physical integrity of Montmorillonite materials, instead a repeated hydration procedure was employed.

### Materials Used

Montmorillonite A, a commercial Australian sodium Montmorillonite, stated to be at least 94% Montmorillonite, routinely screened with a mesh #20 sieve or 0.85 mm mesh opening, to ensure good water retention.

Montmorillonite B, a commercial Australian calcium Montmorillonite, actually sold as a sandy soil improver.

Hypocalcic sodium activated Montmorillonite clay alpha powder—a commercial product stated to be at least 94% Montmorillonite and to have approximately 0.5% calcium ions and approximately 1.9% sodium ion contents by weight as is, and 99-100% being less than 0.25 mm in size. Activated by treatment with sodium carbonate.

TABLE 1
Sand based hydration trials

| | | | | Measured | | |
|---|---|---|---|---|---|---|
| | | | | increase in | | |
| | Amount in | | | water holding | | |
| | 1.8 kg dry | | | capacity over | Calculated | |
| | medium | | | 1.8 kg sand | expected | |
| | Percentage | | | and days | increase in | Difference |
| | weight/weight | Hydration | | allowed to | water holding | from |
| Test material added | (g) | time (min) | | drain (g) | capacity (g) | expected (g) |
| None (washed sand) | | 60 | mins | Background | | |
| | | | | sand | | |
| | | | | retainment | | |
| | | | | [48-3 hours] | | |
| | | | | [43-1 day] | | |
| | | | | [30-2 days] | | |
| | | | | [23-3 days] | | |
| | | | | [20-4 days] | | |
| | | | | [18-5 days] | | |
| Zeolite A ground | 4%-72 g | 70 | mins | 38-1 day | | |
| Zeolite B powder | 4%-72 g | 66 | mins | 24-2 days | | |
| | | | | 11-3 days | | |
| Montmorillonite A | 4%-72 g | 107 | mins | 339-1 day | | |
| granulated | | | | 334-2 days | | |
| Sodium Montmorillonite | | | | 325-3 days | | |
| | | | | 312-5 days | | |
| Montmorillonite B | 4%-72 g | 80 | mins | 106-1 day | | |
| granulated | | | | 103-2 days | | |
| Calcium Montmorillonite | | | | | | |
| Montmorillonite A | 4%-72 g | 340 | mins | 132-1 day | <158 | No benefit; if |
| granulated + Zeolite A | | | | | (0.4 times the | anything the |
| ground | | | | | value for | combination |
| 60:40 | | | | | Montmorillonite + | interferes |
| | | | | | 0.6 times the | |
| | | | | | value for | |
| | | | | | zeolite A) | |
| Montmorillonite A | 4%-72 g | 106 | mins | 318-1 day | 339-1 day | No benefit; if |
| granulated + Hypocalcic | | | | 319-2 days | 334-2 days | anything the |
| sodium activated | | | | 307-3 days | 325-3 days | combination |
| Montmorillonite alpha | | | | | | interferes |
| powder | | | | | | |
| 97.2:2.8 | | | | | | |
| Montmorillonite A | 4%-73 g | 150 | mins | 324-1 day | ~224 | Increased~83 |
| granulated + Hypocalcic | | | | 321-2 days | ~216 | to~100 |
| sodium activated | | | | 306-3 days | ~204 | |
| Montmorillonite alpha | | | | 283-4 days | ~200 | |
| powder + | | | | | (0.616 times the | |
| Zeolite A ground | | | | | value for | |
| 53.4:8.2:38.4 | | | | | Montmorillonite + | |
| | | | | | 0.384 times | |
| | | | | | the value for | |
| | | | | | zeolite A) | |
| Montmorillonite A | 4%-72 g | 141 | mins | 287-1 day | <192 | Increased~90 |
| granulated + Hypocalcic | | | | 278-3 days | <188 | |
| sodium activated | | | | 259-5 days | <165 | |
| Montmorillonite alpha | | | | | (0.51 times the | |
| powder + | | | | | value for | |
| Zeolite A ground | | | | | Montmorillonite + | |
| 49:2:49 | | | | | 0.49 times the | |
| | | | | | value for | |
| | | | | | zeolite A) | |
| Montmorillonite A | 4%-73 g | 96 | mins | 264-1 day | <227 | Increased+ >96 |
| granulated + Hypocalcic | | | | | (0.616 times the | |
| sodium activated | | | | | value for | |
| Montmorillonite alpha | | | | | Montmorillonite + | |
| powder + | | | | | 0.384 times | |
| Zeolite A ground | | | | | the value for | |
| 57.5:4.1:38.4 | | | | | zeolite A) | |
| Montmorillonite A | 4%-72 g | 70 | mins | 264-2 day | <<156 | Increased+ >108 |
| granulated + Hypocalcic | | | | | (0.4 times the | |
| sodium activated | | | | | value for | |
| Montmorillonite alpha | | | | | Montmorillonite + | |
| powder + | | | | | 0.6 times the | |
| Zeolite A ground | | | | | value for | |
| 30:10:60 | | | | | zeolite A) | |
| Montmorillonite A | 4%-72 g | 88 | mins | 254-2 day | <<156 | Increased+ >98 |
| granulated + Hypocalcic | | | | | (0.4 times the | |
| sodium activated | | | | | value for | |
| Montmorillonite alpha | | | | | Montmorillonite + | |
| powder + | | | | | 0.6 times the | |
| Zeolite A ground | | | | | value for | |
| 20:20:60 | | | | | zeolite A) | |
| Hypocalcic sodium | 4%-72 g | 199 | mins | 217-1 day | <<158 | Increased+ >59 |
| activated Montmorillonite | | | | | (0.4 times the | |
| alpha powder + | | | | | value for | |
| Zeolite A ground | | | | | Montmorillonite + | |
| 40:60 | | | | | 0.6 times the | |
| (No Montmorillonite A | | | | | value for | |
| granulated) | | | | | zeolite A) | |
| Montmorillonite A | Effect of | 206 | mins | 198-2 days | <110 | Increased+ >88 |
| granulated + Hypocalcic | reduction in | | | | (0.612 times the | |
| sodium activated | application | | | | value for | |
| Montmorillonite alpha | level | | | | Montmorillonite + | |
| powder + | 2%-36 g | | | | 0.388 times | |
| Zeolite A ground | | | | | the value for | |
| 57:4.2:38.8 | | | | | zeolite A) | |
| Montmorillonite A | Effect of | 95 | mins | 226-2 days | <154 | Increased+ >72 |
| granulated + Hypocalcic | change of | | | | (0.42 times the | |
| sodium activated | Zeolite | | | | value for | |
| Montmorillonite alpha | 4%-72 g | | | | Montmorillonite + | |
| powder + | | | | | 0.58 times the | |
| Zeolite B ground | | | | | value for | |
| 36.1:6.6:58.3 | | | | | zeolite B) | |
| Montmorillonite B | Effect of | 106 | mins | 96-1 day | 69 | Increased+~27 |
| (calcium Montmorillonite) | change of | | | | (0.516 times the | |
| granulated + Hypocalcic | Bentonite | | | | value for | |
| sodium activated | 4%-73 g | | | | Montmorillonite + | |
| Montmorillonite alpha | | | | | 0.384 times | |
| powder + | | | | | the value for | |
| Zeolite B ground | | | | | zeolite B) | |
| 57.5:4.1:38.4 | | | | | | |

Zeolite sample A, retail product sold in Australia, stated to be predominantly mordenite and clinoptilolite, and to have been formed within the past 250,000 years. To generate ground zeolite, batches approximately 125 to 250 g of zeolite pieces were added to a Breville Blender Kintetix Task BBL550, and the puree and or pulse power settings were used for short periods until the ground volume did not increase further. This typically gives a mixture of sizes, it is preferred that the ground pieces be less than 0.85 mm diameter, and more preferred that a significant proportion be less than 0.5 mm but when a mixture of larger size may be included so long as sufficient less than 1 mm pieces are present to achieve the enhancement of the water capacity of the expansive clay present upon proper hydration. After the physical disruption processing the particle size distribution was approximately 12.7%>0.85 mm, 41.6%<0.85 mm>0.5 mm, and 45.7%<0.5 mm particle size distribution.

Zeolite B, retail product sold in Australia, stated to be approximately 85% clinoptilolite and 15% mordenite and formed during the Carboniferous Age, and was 300 million years old. After the physical disruption processing the majority of particles passed through a mesh #20 sieve or 0.84 mm mesh width.

Sand-retail product sold in Australia for children's sand pits, commercial screened and washed, coarser white silica sand. Spread thinly in trays and dried in a heated cabinet before use.

Potting Mixture, a commercial potting product, Green Grub Potting Mix, manufactured by Richgro Garden Products of Western Australia, described as being formulated as an open draining potting mix that is ideal for most indoor and outdoor plants, including hanging baskets.

TABLE 2
Use of the preparation of the invention in another solid plant growth
medium, demonstrating significant enhancement in water
holding capacity per weight unit incorporated

| | | | Measured | | |
|---|---|---|---|---|---|
| | | | increase in | Calculated | Increase g |
| | | | water holding | expected | of |
| | Amount in 1 | | capacity and | increase in | water per |
| | litre hydrated | Hydration | days draining | water holding | gram |
| Test material | medium (g) | time | per litre (g) | capacity (g) | additive |
| Commercial | | 19 hours | 438-1 day | | |
| potting mix | | | 436-2 days | | |
| | | | 432-3 days | | |
| Commercial | 2.1 g/100 g | 19 hours | 488-1 day | 50-1 day | 5.3 |
| potting mix | w/w | Plus | 483-2 days | 47-2 days | 5.0 |
| Montmorillonite | 467 g/hydrated | 8 hours | 479 3 days | 47-3 days | 5.0 |
| A granulated + | litre | | | | |
| Hypocalcic | 9.46 g/hydrated | | | | |
| sodium activated | | | | | |
| Montmorillonite | | | | | |
| alpha powder + | | | | | |
| Zeolite A | litre | | | | |
| ground | | | | | |
| 58:3:39 | | | | | |

TABLE 3
Effect of incorporation of ground zeolite upon rate of Montmorillonite
hydration, monitored by colour up of dye from hydration water
and the development of amorphous appearing phase

| | Amount in | | | | |
|---|---|---|---|---|---|
| | 1.8 kg dry | | | | |
| | medium | | | | |
| | Percentage | | | | Change in appearance of |
| | weight/weight | | Hydration | | Montmorillonite particles |
| Test material added | (g) | | time | | under magnification |
| Montmorillonite A | 0.76%-13.6 | g | 24 | hours | 20 minutes patches grainy, |
| granulated + Hypocalcic | | | | | granular-show structure |
| sodium activated | | | | | 110 minutes grainy patches, |
| Montmorillonite alpha | | | | | centre of patches still pale |
| powder | | | | | 190 minutes patches still grainy but |
| 95:5 | | | | | outer edge smushy in appearance |
| Montmorillonite A | 4%-72 | g | 23.5 | hours | 205 minutes still hydrating |
| granulated + Zeolite A | | | | | 300 minutes last visible |
| ground | | | | | patch colouring, |
| 40:60 | | | | | 340 minutes last visible patch |
| | | | | | slightly coloured. |
| Hypocalcic sodium | 4%-72 | g | 260 | mins | Hydration continuing at 15 minutes |
| activated Montmorillonite | | | | | and essentially complete |
| alpha powder + | | | | | in 50 minutes |
| Zeolite A ground | | | | | |
| 40:60 | | | | | |
| Montmorillonite A | 4%-72 | g | 75 | mins | Hydration extensively complete |
| granulated + Hypocalcic | | | | | in 3 minutes and essentially |
| sodium activated | | | | | complete in 4 minutes |
| Montmorillonite alpha | | | | | |
| powder + | | | | | |
| Zeolite A ground | | | | | |
| 30:10:60 | | | | | |
| Montmorillonite A | 4%-72 | g | 75 | mins | Hydration extensively complete |
| granulated + Hypocalcic | | | | | in 8 minutes and essentially |
| sodium activated | | | | | complete in 9.5 minutes |
| Montmorillonite alpha | | | | | |
| powder + | | | | | |
| Zeolite A ground | | | | | |
| 39:3:58 | | | | | |
| Montmorillonite A | 4%-72 | g | 136 | mins | Hydration essentially |
| granulated + Hypocalcic | | | | | complete in 12 minutes |
| sodium activated | | | | | |
| Montmorillonite alpha | | | | | |
| powder + | | | | | |
| Zeolite A ground | | | | | |
| 47.2:4.2:48.5 | | | | | |
| Montmorillonite A | 4%-73 | g | 102 | mins | Hydration essentially |
| granulated + Hypocalcic | | | | | complete in 5 minutes |
| sodium activated | | | | | |
| Montmorillonite alpha | | | | | |
| powder + | | | | | |
| Zeolite A ground | | | | | |
| 53.4:8.3:38.3 | | | | | |
| Montmorillonite A | 3%-54 | g | 88 | mins | Hydration essentially complete |
| granulated + Hypocalcic | | | | | in 6 minutes some grainy core |
| sodium activated | | | | | remaining, structure gone |
| Montmorillonite alpha | | | | | 11.5 minutes |
| powder + | | | | | |
| Zeolite A ground | | | | | |
| 58:3:39 | | | | | |
| Montmorillonite A | 2.5%-45 | g | 189 | mins | Hydration essentially |
| granulated + Hypocalcic | | | | | complete in 13 minutes |
| sodium activated | | | | | |
| Montmorillonite alpha | | | | | |
| powder + | | | | | |
| Zeolite A ground | | | | | |
| 58:3:39 | | | | | |

Second testing procedure the testing vessels used were slopping sided plastic food containers, base approximately 7 cm broad and 16 cm long, height 16 cm.

The procedure used a litre quantity of damp sand, with or without amendments of 10 g.

The dry individual ingredients or dry mixture preparations were thoroughly mixed with the sand in a bowl and loaded into the container, and water slowly added to achieve complete wetting, and additionally to have a liquid layer of approximately one cm above the surface of the sand or sand mixture.

The container contents are allowed to hydrate for approximately a day.

The containers are inverted over a pad of approximately 6.5 cm thickness of paper towels. After several minutes a knife is inserted between the side of the container and the hydrated sand material so that the sand material falls and establishes effective functional contact with the pad of paper towels. Afterwards an air channel was made between the side of the container and the sand material to ensure that no water seal and thus a semi vacuum would occur inside the container to restrict effective duplication of deep percolation.

The hydrated sand mixture was allowed to drain for 24 hours, before the containers and contents were turned upright. Sand adhering to the paper pad was gently scraped into the container.

The drained hydrated sand mixture was weighted. The increase in weight of the drained sand material with amendment over the weight of the drained unamended sand material, minus the weight of added amendment, gave the increase in water holding achieved by the incorporation of the amendment.

Hypocalcic natural Montmorillonite clay powder was used. This is a commercial product stated to be at least 90% Montmorillonite and to have typically 0.07% calcium ions and typically 2.0% sodium plus potassium ion contents by weight as is, and 95% or more being less than 2 mm in size.

Zeolite sample A, retail product sold in Australia, stated to be predominantly mordenite and clinoptilolite, and to have been formed within the past 250,000 years. To generate ground zeolite, batches approximately 125 to 250 g of zeolite pieces were added to a Breville Blender Kintetix Task BBL550, and the puree and or pulse power settings were used for short periods until the ground volume did not increase further. This typically gives a mixture of sizes, it is preferred that the ground pieces be less than 0.85 mm diameter, and more preferred that a significant proportion be less than 0.5 mm but when a mixture of larger size may be included so long as sufficient less than 1 mm pieces are present to achieve the enhancement of the water capacity of the expansive clay present upon proper hydration.

After the physical disruption processing the particle size distribution was approximately 12.7%>0.85 mm, 41.6%<0.85 mm>0.5 mm, and 45.7%<0.5 mm particle size distribution.

Sand—drained damp retail product sold in Australia for building applications, commercial screened and washed, coarse white silica sand.

TABLE 4
Sand based hydration trials with second procedure

| | Increase in | Calculated | Increase in |
|---|---|---|---|
| | water | increase in | water |
| | holding after | water holding | holding |
| | 24 hours | without | ascribed to |
| Amendment | draining | synergy | synergy |
| Ground Zeolite 10 g | 8 g | | |
| Powdered natural hypocalcic | 48 g | | |
| Montmorillonite expansive | | | |
| clay 10 g | | | |
| Natural Hypocalcic | 118 g | 31.5 g | 86.5 g |
| Montmorillonite expansive | | | |
| clay 5 g combined with | | | |
| Zeolite 5 g | | | |
| Natural Hypocalcic | 155 g | 43 g | 112 g |
| Montmorillonite expansive | | | |
| clay 8.5 g combined with | | | |
| Zeolite 1.5 g | | | |

The results obtained ably demonstrate that the water holding capacity of the sodium activated Montmorillonite alpha powder is slightly lower than that of Montmorillonite A granules and so the retention of combinations are at best equal to the value for the Montmorillonite A granules.

Using the increases in water holding capacity in sand achieved individually by a sodium Montmorillonite A, Sodium activated Montmorillonite, and by Zeolite, the combining of Montmorillonite A with Sodium activated Montmorillonite does not show enhanced water holding capacity, but enhancement or synergy for water holding capacities is shown with combining Zeolite A and Hypocalcic sodium activated Montmorillonite capacity and with combining Zeolite A, Montmorillonite A and Hypocalcic Sodium activated Montmorillonite.

Using the increases in water holding capacity in sand achieved individually by a natural Hypocalcic Montmorillonite expansive clay, and by Zeolite A, enhancement or synergy for water holding capacities is shown with combining Zeolite A and natural Hypocalcic Montmorillonite expansive clay.

Using the increases in water holding capacity in sand achieved individually by a calcium Montmorillonite B, Sodium activated Montmorillonite, and by Zeolite, enhancement or synergy for water holding capacities is shown with the combination of Zeolite A, Montmorillonite B and Sodium activated Montmorillonite.

Using the increases in water holding capacity in sand achieved individually by an alternative zeolite-Zeolite B, by Montmorillonite A, and by Sodium activated Montmorillonite enhancement or synergy for water holding capacities is shown with combination of Zeolite B, Montmorillonite A and Sodium activated Montmorillonite.

Enhancements occurred even under draining conditions which ensure essentially no gravitational or capillary water is present in the media, and when there are significant ongoing diffusion evaporation losses occurring over several days. The potential for enhancement not being dependent on a single set additive incorporation rate, nor restricted to a single precise particle size distribution of the ground zeolite.

Even when the nature of the media is changed, the preparation of the invention demonstrates significant enhancement of water holding capabilities per unit of additive.

The speed or rate of hydration of expansive clay or clays is enhanced by the incorporation of sodium Montmorillonite and zeolite combination.

Using the increases in water holding capacity in sand achieved individually by a calcium Montmorillonite B, Sodium activated Montmorillonite, and by Zeolite, enhancement or synergy for water holding capacities is shown with the combination of Zeolite A, calcium Montmorillonite B and Sodium activated Montmorillonite.

### INDUSTRIAL APPLICABILITY

The preparations enable more efficient use of water and of dissolved plant nutrients, and more productive and robust plant growth. Applications of the plant growth media applications utilising the water holding capacity additives can include but are not limited to agricultural, horticultural, vinicultural, orchards and forestry, plant nursery operations, green and glass houses, garden plants, indoor plants, potted plants, flower production, decorative roles including epiphytes, maintenance of parks, sports grounds, lawns and erosion control areas, during land reclamation, and in restoration of degraded and contaminated areas.

### REFERENCES

International Agrophysics., volume 30, pages 391-399, 2016, doi: 10.1515/intag-2016-0009, ‘Comparing the potentials of clay and biochar in improving water retention and mechanical resilience of sandy soil’ by Ayodele Ebenezer Ajayi and Rainer Horn).
Forests 2016, volume 7, 21 pages, 2016, ‘Effects of Bentonite, Charcoal and Corncob for Soil Improvement and Growth Characteristics of Teak Seedling Planted on Acrisols in Northeast Thailand’ by Masazumi Kayama, Suchat Nimpila, Sutjaporn Hongthong, Reiji Yoneda, Wilawan Wichiennopparat, Woraphun Himmapan, Tosporn Vacharangkura and Iwao Noda.
‘Hydrophysical properties and moisture regime in the unsaturated zone’, by A. A. Rode, pages 33-48, of ‘Water in the unsaturated zone’ Proceedings of the Wageningen Symposium, ASH/AIHS-Unesco, Studies and reports in hydrology, Published in 1969 by the International Association of Scientific Hydrology, Braamstraat 61, Gentbrugge and by Unesco, Place de Fontenoy, 75 Paris-7e.

1. A synergetic preparation for enhancing the water holding capacities of solid plant growth medium, the preparation comprising:
a) ground zeolite;
b) powdered hypocalcic Montmorillonite expansive clay, and optionally;
c) granular non hypocalcic Montmorillonite expansive clay.

2. The preparation of claim 1, wherein the hypocalcic Montmorillonite expansive clay has less than about 0.6 g of calcium per 100 g of the Montmorillonite component, on a dry weight basis.

3. The preparation of claim 1, wherein the hypocalcic Montmorillonite expansive clay has less than about 0.5 g of calcium per 100 g of the Montmorillonite component, on a dry weight basis.

4. The preparation of claim 1, wherein the hypocalcic Montmorillonite expansive clay has less than about 0.25 g of calcium per 100 g of the Montmorillonite component, on a dry weight basis.

5. The preparation of claim 1, wherein the hypocalcic Montmorillonite expansive clay has less than about 0.1 g of calcium per 100 g of the Montmorillonite component, on a dry weight basis.

6. The preparation of any one of claims 1 to 5, wherein the weight ratio of zeolite to expansive clay is between about 1 to 0.25 and about 1 to 30.

7. The preparation any one of claims 1 to 5, wherein the weight ratio of zeolite to expansive clay is between about 1 to 0.5 and about 1 to 20.

8. The preparation of any one of claims 1 to 5, wherein the weight ratio of zeolite to expansive clay is between about 1 to 0.8 and about 1 to 12.

9. The preparation of any one of claims 1 to 8, wherein the weight ratio of powdered hypocalcic Montmorillonite expanse clay in the total amount of expansive clay is between about 2 and 100%.

10. The preparation of any one of claims 1 to 8, wherein the ratio of powdered hypocalcic Montmorillonite expanse clay in the total amount of expansive clay is between about 5 and 100%.

11. The preparation of any one of claims 1 to 8, wherein the ratio of powdered hypocalcic Montmorillonite expanse clay in the total amount of expansive clay is between about 8 and 100%.

12. The preparation of claims 1 to 11 wherein the water in the solid plant growth medium is essentially only suspended water.

13. The preparation of any one of claims 1 to 12, wherein the water in solid plant growth medium is subject to ongoing diffusion evaporation.

14. The preparation of any one of claims 1 to 13, wherein the hydration rate of the non hypocalcic Montmorillonite expansive clay particles are enhanced compared with the rates for non hypocalcic Montmorillonite expansive clay particles in the absence of the zeolite.

15. The preparation of any one of claims 1 to 14, wherein the zeolite has a majority content of mordenite, or clinoptilolite, or a combination of the two chemical forms.

16. The preparation of any one of claims 1 to 14, wherein the ground zeolite particles has an appropriate portion of particles able to be well mixed with the expansive clays.

17. The preparation of any one of claims 1 to 16, wherein the powdered hypocalcic Montmorillonite expansive clay is an alkali metal activated Montmorillonite clay.

18. The preparation of any one of claims 1 to 16, wherein the powdered alkali metal activated expanse clay is activated after the combination of the ingredients as a result of co-incorporation of an alkali metal carbonate or carbonates.

19. The preparation of any one of claims 1 to 18, wherein the powdered hypocalcic Montmorillonite expansive clay is a sodium activated Montmorillonite clay.

20. The preparation of any one of claims 1 to 16, wherein the powdered hypocalcic Montmorillonite expansive clay is an acid activated Montmorillonite clay.

21. The preparation of any one of claims 1 to 16, wherein the powdered hypocalcic Montmorillonite expansive clay is a natural Montmorillonite clay.

22. The preparation of any one of claims 1 to 16, wherein the powdered hypocalcic Montmorillonite expansive clay is a synthetic Montmorillonite clay.

23. The preparation of any one of claims 1 to 22, further comprising one or more organic polymers for temporary water holding capacity enhancement.

24. The preparation of claim 23, wherein the one or more organic polymers are selected from the group consisting of sodium carboxymethyl cellulose, xanthan gum, guar gum, gum arabic, carob bean gum, locust bean gum, tara gum, konjac gum, gellan gum, methyl cellulose, hydroxypropyl methylcellulose, and hydroxyethyl methyl cellulose.

25. The preparation of claim 23, wherein the one or more organic polymers are selected from either sodium carboxymethyl cellulose or xanthan gum.

26. The preparation of any one of claims 1 to 25, further comprising aids for plant growth, or soil microbes, or promoters of soil microbes, or assist in effective product incorporation and distribution into a solid plant growth media.

27. The preparation of any one of claims 1 to 26, wherein the plant growth media is modified natural soil, or altered soil, or synthetic soil, or soil substitute, or sand, or potting mixes, composted material, raised bed media, or hydroponic media, or mushroom growth media, or epiphyte media.

28. The preparation of any one of claims 1 to 27, wherein the plant growth media utilises one or more of plastics, expanded mica, expanded perlite, heat treated vermiculite, treated barks, quartz sand, silt, grit, gravel, ground and fragmented rock, mineral dust, pumice, wood fibres, shredded wood, peat, coconut coir, sawdust, fresh bark, aged bark, composted bark, peanut shells, cork, rice hulls, coffee grinds, sugarcane leaves, sugarcane tops, sugarcane bagasse, cereal straw, chaff, and compost.

29. Modified plant growth media containing an additive comprising a synergetic preparation for enhancing the water holding capacities of solid plant growth medium, the preparation comprising:
a) ground zeolite;
b) powdered hypocalcic Montmorillonite expansive clay, and optionally;
c) granular non hypocalcic Montmorillonite expansive clay.

30. The modified plant growth media of claim 29, wherein the hypocalcic Montmorillonite expansive clay has less than about 0.6 g of calcium per 100 g of the Montmorillonite component, on a dry weight basis.

31. The modified plant growth media of claim 29, wherein the hypocalcic Montmorillonite expansive clay has less than about 0.5 g of calcium per 100 g of the Montmorillonite component, on a dry weight basis.

32. The modified plant growth media of claim 29, wherein the hypocalcic Montmorillonite expansive clay has less than about 0.25 g of calcium per 100 g of the Montmorillonite component, on a dry weight basis.

33. The modified plant growth media of claim 29 wherein the hypocalcic Montmorillonite expansive clay has less than about 0.1 g of calcium per 100 g of the Montmorillonite component, on a dry weight basis.

34. The modified plant growth media of any one of claims 29 to 33, wherein the weight ratio of zeolite to expansive clay is between about 1 to 0.25 and about 1 to 30.

35. The modified plant growth media of any one of claims 29 to 33, wherein the weight ratio of zeolite to expansive clay is between about 1 to 0.5 and about 1 to 20.

36. The modified plant growth media of any one of claims 29 to 33, wherein the weight ratio of zeolite to expansive clay is between about 1 to 0.8 and about 1 to 12.

37. The modified plant growth media of any one of claims 29 to 36, wherein the water in the modified solid plant growth medium is essentially only suspended water.

38. The modified plant growth media of any one of claims 29 to 37, wherein the water in the modified solid plant growth medium is subject to ongoing diffusion evaporation.

39. The modified plant growth media of any one of claims 29 to 38, wherein the hydration rate of the non hypocalcic Montmorillonite expansive clay particles are enhanced compared with the rates for non hypocalcic Montmorillonite expansive clay particles in the absence of the zeolite.

40. The modified plant growth media of any one of claims 29 to 39, wherein the zeolite has a majority content of mordenite, or clinoptilolite, or a combination of the two chemical forms.

41. The modified plant growth media of any one of claims 29 to 40, wherein the powdered hypocalcic Montmorillonite expansive clay is an alkali metal activated Montmorillonite clay.

42. The modified plant growth media of claim 41, wherein the powdered hypocalcic Montmorillonite expansive clay is a sodium activated Montmorillonite clay.

43. The modified plant growth media of claims 29 to 40, wherein the powdered hypocalcic Montmorillonite expansive clay is an acid activated Montmorillonite clay.

44. The modified plant growth media of any one of claims 29 to 40, wherein the powdered hypocalcic Montmorillonite expansive clay is a natural Montmorillonite clay.

45. The modified plant growth media of any one of claims 29 to 40, wherein the powdered hypocalcic Montmorillonite expansive clay is a synthetic Montmorillonite clay.

46. The modified plant growth media of any one of claims 29 to 45, wherein the further components include organic polymer or polymers for temporary water holding capacity enhancement.

47. The modified plant growth media of claim 46, wherein the organic polymer or polymers are selected from the group consisting of sodium carboxymethyl cellulose, xanthan gum, guar gum, gum arabic, carob bean gum, locust bean gum, tara gum, konjac gum, gellan gum, methyl cellulose, hydroxypropyl methylcellulose, and hydroxyethyl methyl cellulose.

48. The modified plant growth media of claim 46, wherein the organic polymer or polymers are selected from either sodium carboxymethyl cellulose or xanthan gum.

49. The modified plant growth media of any one of claims 29 to 48, further comprising aids for plant growth, or soil microbes, or promoters of soil microbes.

50. The modified plant growth media of any one of claims 29 to 49, wherein the plant growth media is modified natural soil, or altered soil, or synthetic soil, or soil substitute, or sand, or potting mixes, composted material, raised bed media, or hydroponic media, or mushroom growth media, or epiphyte media.

51. The modified plant growth media of any one of claims 29 to 50, wherein the plant growth media utilises one or more of plastics, expanded mica, expanded perlite, heat treated vermiculite, treated barks, quartz sand, silt, grit, gravel, ground and fragmented rock, mineral dust, pumice, wood fibres, shredded wood, peat, coconut coir, sawdust, fresh bark, aged bark, composted bark, peanut shells, cork, rice hulls, coffee grinds, sugarcane leaves, sugarcane tops, sugarcane bagasse, cereal straw, chaff, and compost.
